(19) United States
(12) Patent Application Publication
(10) Pub. No.: US 2026/0343572 A1
(43) Pub. Date: Oct. 29, 2026

(54) ENHANCED SEARCH AND ACCESS VIA MODIFIED PHYSICAL BROADCAST CHANNEL (PBCH)

(71) Applicant: QUALCOMM Incorporated, San Diego, CA (US)

(72) Inventors: Navid ABEDINI, Basking Ridge, NJ (US); Igor GUTMAN, Hod HaSharon (IL); Tao LUO, San Diego, CA (US)

(21) Appl. No.: 19/355,730

(22) Filed: Oct. 10, 2025

Related U.S. Application Data
(60) Provisional application No. 63/795,105, filed on Apr. 25, 2025.

(51) Int. Cl. H04W 72/30

(52) U.S. Cl. CPC H04W 72/30

(57) ABSTRACT

Certain aspects of the present disclosure focus on techniques for dividing information carried by a physical broadcast channel (PBCH) into common information (e.g., which is applicable to multiple gNodeBs (gNBs)) and non-common information (e.g., which is specific to an individual gNB). A gNB may transmit the PBCH along with an indication distinguishing the common information from the non-common information to a user equipment (UE).

### CROSS-REFERENCE TO RELATED APPLICATION

This application claims benefit of and priority to U.S. Provisional Application No. 63/795,105, filed Apr. 25, 2025, which is hereby incorporated by reference in its entirety.

### BACKGROUND

### Field of the Disclosure

Aspects of the present disclosure relate to wireless communications, and more particularly, to techniques for managing physical broadcast channel (PBCH) information.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the technical challenges and others.

### SUMMARY

One aspect provides a method for wireless communications at a user equipment (UE). The method may include receiving a synchronization signal block (SSB) including at least a physical broadcast channel (PBCH) from a first network entity, wherein the PBCH includes, 1) first information applicable to multiple network entities including at least the first network entity and a second network entity and 2) second information that is specific to one or more of the multiple network entities. The method may further include decoding the SSB.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network, in accordance with certain aspects of the present disclosure.

FIG. 2 depicts an example disaggregated base station (BS) architecture, in accordance with certain aspects of the present disclosure.

FIG. 3 depicts aspects of an example BS and an example user equipment (UE), in accordance with certain aspects of the present disclosure.

FIG. 4A, FIG. 4B, FIG. 4C, and FIG. 4D depict various example aspects of data structures for a wireless communications network, in accordance with certain aspects of the present disclosure.

FIG. 5 depicts a call flow diagram that illustrates an example of communication between various wireless nodes, in accordance with certain aspects of the present disclosure.

FIG. 6 depicts an example of physical broadcast channel (PBCH) information, in accordance with certain aspects of the present disclosure.

FIG. 7 depicts a method for wireless communications at a UE, in accordance with certain aspects of the present disclosure.

FIG. 8 depicts example wireless node, in accordance with certain aspects of the present disclosure.

### DETAILED DESCRIPTION

A physical broadcast channel (PBCH) may carry system information intended for a user equipment (UE). This information may include a system frame number, sub carrier spacing information, and other relevant parameters. While the PBCH may usually contain gNodeB (gNB)-specific information (e.g., information tailored to a particular gNB), certain portions of this information may be configured to be common across multiple gNBs.

To enhance flexibility and efficiency, the present disclosure describes techniques for segmenting (or dividing) the information carried by the PBCH into common information (e.g., shared across multiple gNBs) and non-common information (e.g., specific to an individual gNB). The gNB may transmit the PBCH along with an indication that enables the UE to distinguish between the common and non-common portions.

This segmentation of PBCH content into common and non-common information may be defined according to wireless standards (i.e., standardized) and/or flexibly configured by the gNB. When the split (i.e., which information is included in the common part) is flexibly configured, the segmentation details may be conveyed to the UE through any combination of master information block (MIB), system information block (SIB), dedicated radio resource control (RRC) signaling, medium access control-control element (MAC-CE), pre-configuration, or over-the-top (OTT) mechanisms.

Dividing the PBCH in this manner may lead to improved resource efficiency. For example, it may allow the UE to avoid reprocessing the common information when transitioning between gNBs, which may reduce power consumption. Similarly, the gNB can optimize energy usage by transmitting the common information only when necessary. Overall, this approach may help enhance energy and resource efficiency for both the UE and the gNB, resulting in improved performance and reduced operational costs.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

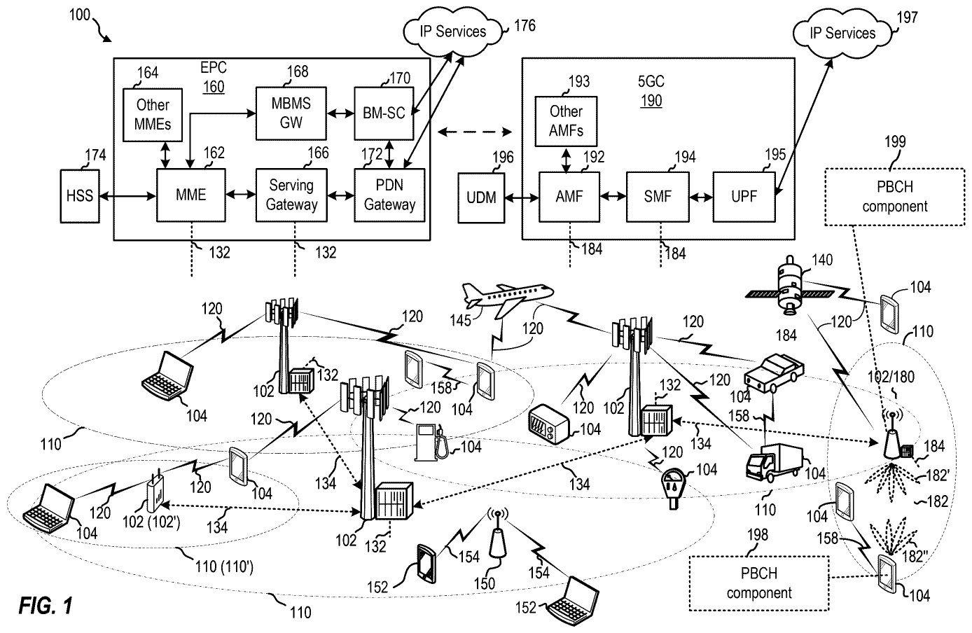

FIG. 1 depicts an example of a wireless communications network 100, in which aspects described herein may be implemented.

Wireless communications network 100 includes various network entities (alternatively, network elements or network nodes). A network entity is a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others. UEs 104 may operate as relay devices.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

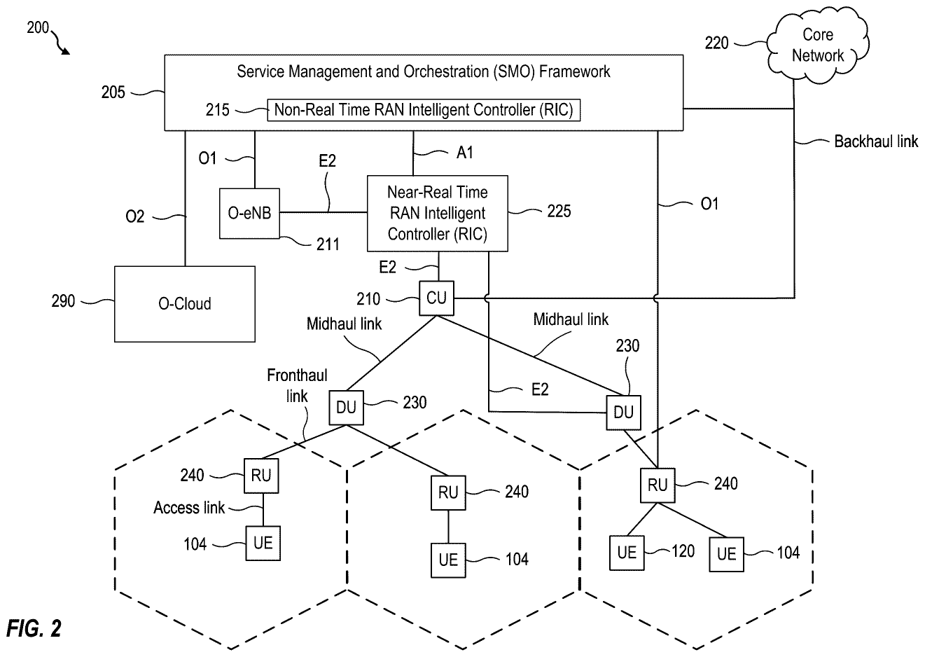

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 130) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. MME 162 provides bearer and connection management.

User Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

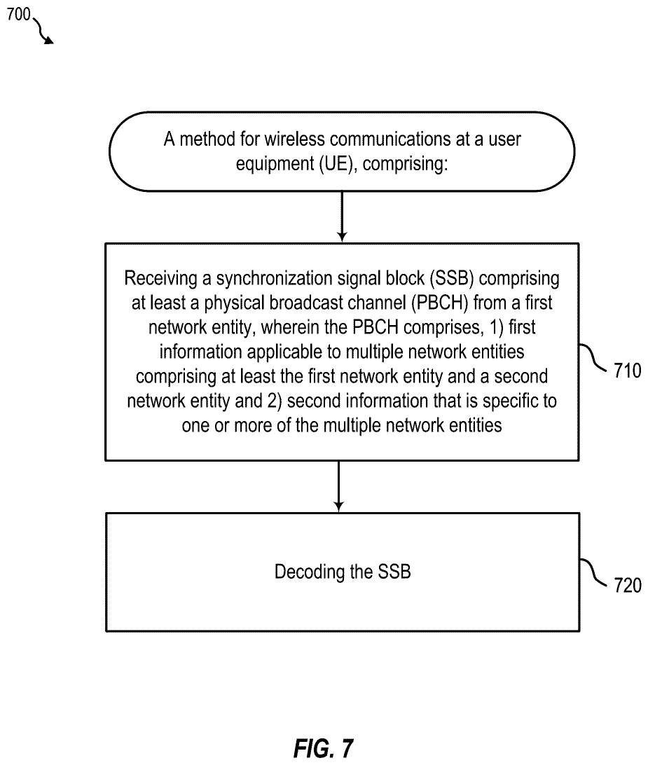

Wireless communication network 100 further includes physical broadcast channel (PBCH) component 198, which may be configured to perform method 700 of FIG. 7. Wireless communication network 100 further includes PBCH component 199, which may be configured to perform method 700 of FIG. 7.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

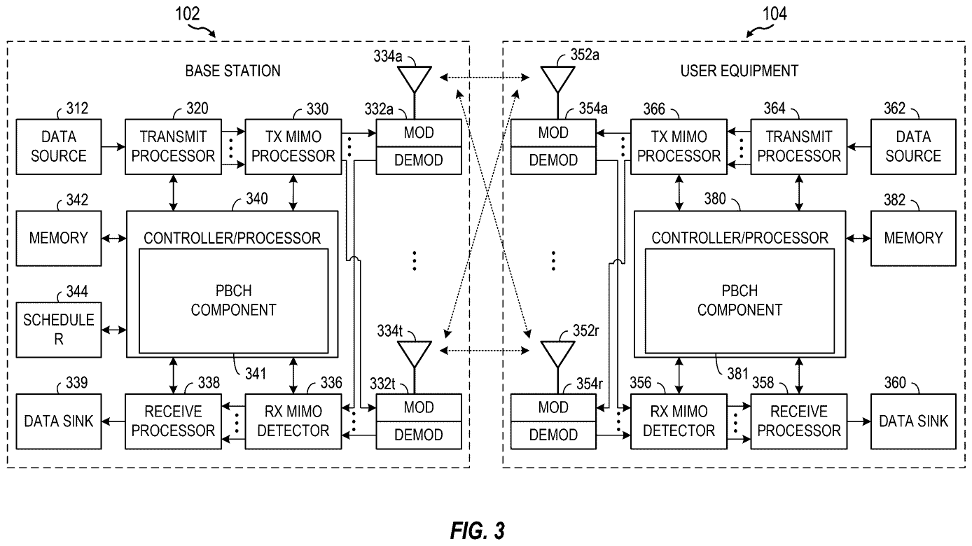

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes PBCH component 341, which may be representative of PBCH component 199 of FIG. 1. Notably, while depicted as an aspect of controller/processor 340, PBCH component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes PBCH component 381, which may be representative of PBCH component 198 of FIG. 1. Notably, while depicted as an aspect of controller/processor 380, PBCH component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical Hybrid Automatic Repeat Request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

To receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

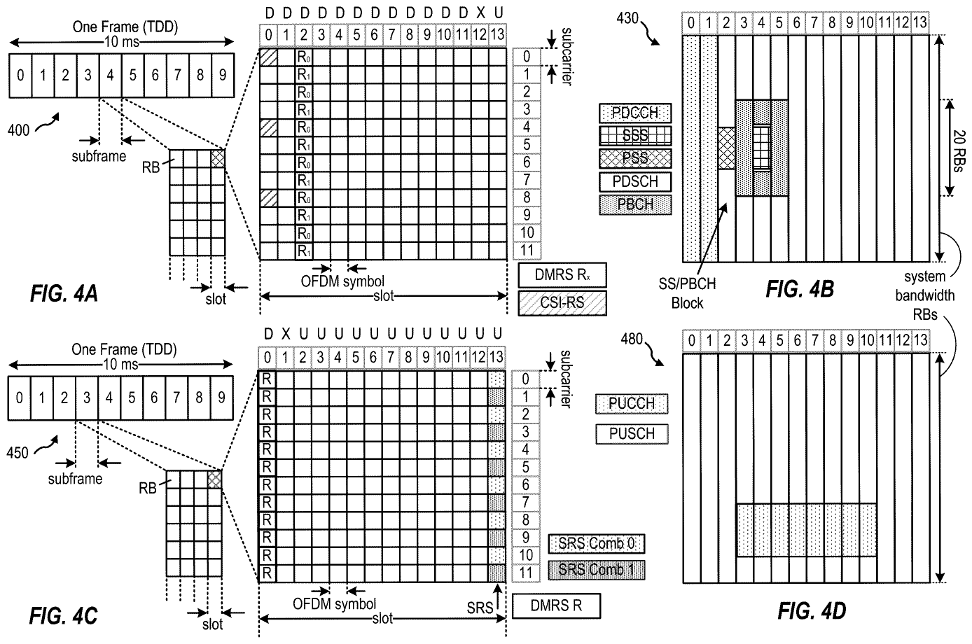

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of subframes of a frame. The PSS is used by a UE (e.g., 104 of FIG. 1 and FIG. 3) to determine subframe/symbol timing and a physical layer identity.

A secondary synchronization signal (SSS) may be within symbol 4 of subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard (TS) 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Synchronization Signal Block (SSB)

A synchronization signal block (SSB) is a transmission that may be sent by a base station (BS) to help a user equipment (UE) discover and synchronize with a network. The SSB is a first signal the UE may search for during initial access procedures, such as powering on, performing a cell search, or recovering from a radio link failure. It may provide the UE with essential timing, frequency, and basic system configuration information required for establishing a connection.

The SSB may consist of multiple components such as: a primary synchronization signal (PSS), a secondary synchronization signal (SSS), a physical broadcast channel (PBCH), and PBCH demodulation reference signals (DMRS). The PSS may allow the UE to determine the symbol timing and part of a physical cell ID (PCI), while the SSS may help the UE derive frame timing, cyclic prefix type, and the remaining bits of the PCI. Together, the PSS and the SSS may enable the UE to identify a serving cell. The PBCH may carry a master information block (MIB), which may include configuration parameters such as system frame number (SFN), subcarrier spacing, and/or SSB periodicity. The PBCH may be accompanied by DMRS, which may assist the UE in performing channel estimation for reliable PBCH decoding.

The SSB may occupy a fixed structure in a time-frequency domain. It may be transmitted periodically, with a periodicity of 10-20 milliseconds, though other values may be configured depending on network settings. To support beamforming, the BS may transmit multiple SSBs per SSB burst, each in a different spatial direction, in a process known as beam sweeping. Depending on the operating frequency range and deployment scenario, up to N number of SSBs may be transmitted per burst.

### Overview of Physical Broadcast Channel (PBCH)

A physical broadcast channel (PBCH) is a crucial component of wireless communication systems. It may be periodically transmitted by a base station (BS) to provide essential system information to all user equipments (UEs) within a or associated with a cell. This channel may serve as the primary means for the UEs to access and connect to a network by broadcasting key parameters needed for synchronization and communication. The PBCH may help the UEs with initial access, cell identification, and/or establishing synchronization with the network.

A payload carried on the PBCH may include a mixture of dynamic (e.g., time-varying) and static/semi-static information. Dynamic information may refer to parameters that change frequently from one transmission to another (e.g., reflecting the real-time conditions of the network). A key example may be a system frame number (SFN), which may ensure that the UE is properly synchronized with the network timing. The SFN may be updated with each transmission of the PBCH, and thus aligning the UE internal clock with the network time. Additionally, a beam index may be another dynamic parameter used in wireless systems, where beamforming may be employed. The beam index may help the UE adjust to different beam directions or configurations, which can change based on network real-time decisions for optimal signal quality and coverage.

In contrast, static or semi-static information may consist of parameters that remain unchanged over time or change infrequently. These parameters may provide a UE with essential cell configuration details that are necessary for continued network access. For instance, a half-frame indicator denotes whether a current transmission corresponds to a first or second half of a frame, and thus aiding the UE in maintaining synchronization with a network frame structure. Cell barring information may indicate whether the cell is currently barring access for new UEs or certain services. Another key piece of static information is cell reselection information, which may guide the UE on when to switch to another cell based on factors such as signal strength or load balancing requirements.

The PBCH role in enabling network access is essential. It may be a first point of contact between the UE and the network, as it allows the UE to synchronize with a correct cell and begin a random access channel (RACH) procedure, which is essential for establishing a connection. The dynamic information may help the UE stay in sync with the network, while the static information may ensure that the UE can remain connected and follow the cell configuration over time.

### Aspects Related to Enhanced Search and Access via Modified PBCH

In new radio (NR), a physical broadcast channel (PBCH) transmitted by a gNodeB (gNB) to a user equipment (UE), carries information necessary for initial synchronization and communication between the UE and a network. The PBCH content may be specific to a transmitting gNB (i.e., the information is tailored to a cell or base station (BS) providing the transmission). However, certain elements of this information, such as system parameters and configurations, can be shared across multiple gNBs to optimize the broadcast.

To increase flexibility and efficiency, the techniques described herein propose a method for dividing the information carried on the PBCH into two distinct categories: common information and non-common information (also known as cell-specific information). The common information may be applicable to multiple gNBs or cells, while non-common information may be unique to a specific gNB or cell. By introducing this differentiation, the gNB may transmit the PBCH with an indication that distinguishes between the common and non-common information. This enables the UE to easily identify and process the relevant data.

The advantage of this approach is that, while the PBCH still carries necessary cell-specific details, such as a scrambling identifier (ID), PBCH demodulation reference signal (DMRS), and elements from a master information block (MIB), it allows for certain parameters to be configured in a way that can be shared across the multiple cells. For example, while some cell configurations may be unique to a particular gNB, others, such as timing and system frame numbers (SFNs), can be common across the multiple cells. This flexibility in splitting the PBCH content into common and non-common parts may provide a significant opportunity for optimization.

By separating the PBCH information into these categories, the system may leverage the common information to reduce redundancy, which may lead to improved resource utilization and lower energy consumption. This may be important in reducing overhead on both the UE and the gNB sides.

Additionally, by optimizing how network resources are allocated through the flexible use of the common and non-common information, the overall network efficiency improves. The UE can focus its processing power on critical cell-specific data, while the gNB can use the same transmission resources to broadcast more efficient, generalized information that is applicable across the multiple cells.

In synchronized deployments, cells may be aligned by the SFN, which results in a shared common SFN and potentially a common half-frame number. In the case of tightly synchronized cells, a synchronization signal block (SSB) index (or at least a part of it) depending on a maximum round trip time (RTT) or inter-site distance (ISD) may be common across different cells. Alternatively, the SSB index can be inferred from timing information obtained from another cell. This flexibility may also depend on an actual SSB positions within an SSB burst. Even without tight downlink (DL) reception timing alignment, if the transmitted SSBs are selected to be non-consecutive, SSB indices can be inferred without ambiguity. Additionally, depending on the specific implementation or configuration, other elements may be set as common, such as a barring flag, subcarrier spacing (SCS), radio network temporary identifier (RMSI), and physical downlink control channel (PDCCH) configuration.

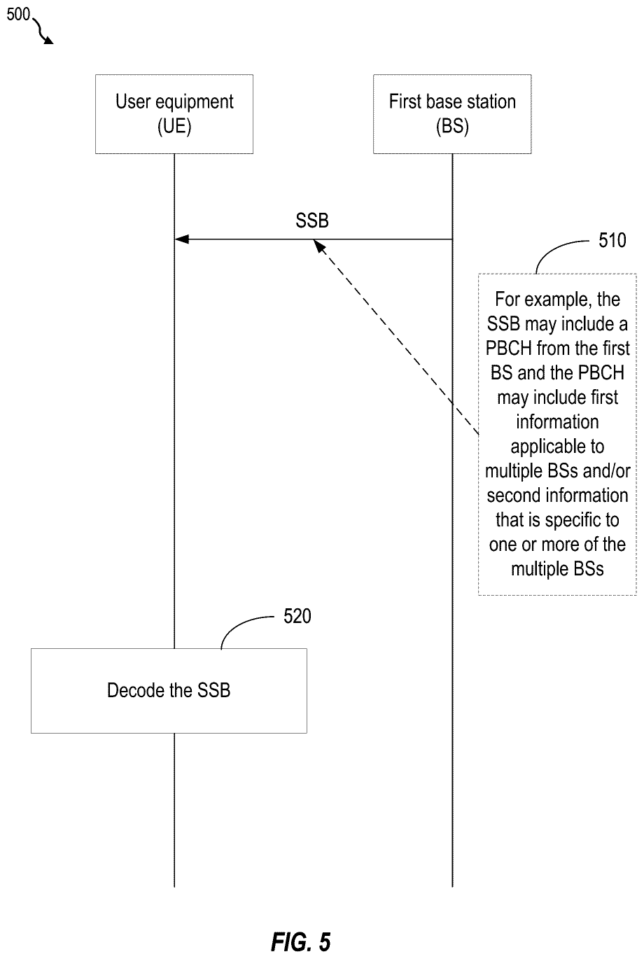

The techniques proposed herein may be further understood with reference to FIG. 5-FIG. 8.

FIG. 5 depicts a call flow diagram 500 that illustrates an example of communication between various wireless nodes, such as a UE and a first BS (or cell). The UE shown in FIG. 5 may correspond to the UE 104 described in connection with FIGS. 1 and 3. Similarly, the first BS depicted in FIG. 5 may represent the BS 102 referenced in FIGS. 1 and 3, or the disaggregated BS illustrated and discussed with respect to FIG. 2.

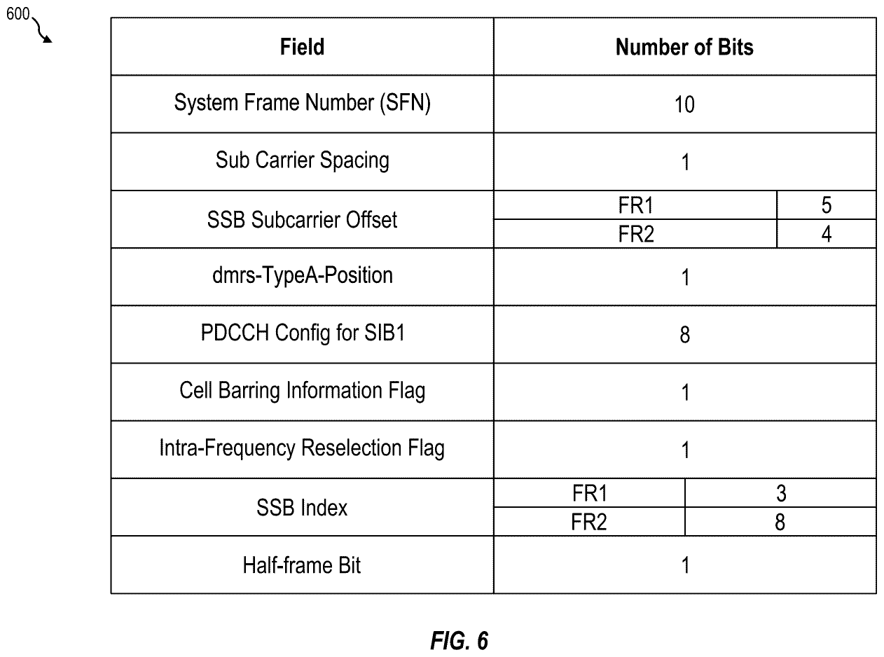

As shown at 510, the first BS transmits an SSB to the UE. The SSB may include a PBCH. Various fields/parameters of PBCH information carried by the PBCH are shown in table 600 of FIG. 6. For example, the various fields/parameters of the PBCH information may include the SFN, the SCS, an SSB subcarrier offset, DMRS type A position, PDCCH configuration for a system information block (SIB) 1, a cell barring information flag, an intra-frequency reselection flag, an SSB index, and a half frame bit.

The PBCH may include first information (e.g., common information) that may be applicable to multiple BSs (e.g., such as cells or gNBs) including the first BS and a second BS (or cell). The first information may include a first set of fields/parameters of the PBCH information (e.g., which may be selected from the various fields/parameters shown in the table 600).

The PBCH may include second information (e.g., non-common information) that is specific to one or more of the multiple BSs. For example, the second information may be specific to the first BS. The second information may include a second set of fields/parameters of the PBCH information (e.g., which may be selected from the various fields/parameters shown in the table 600). The second set of fields/parameters of the PBCH information may be different from the first set of fields/parameters of the PBCH information.

Referring to FIG. 5, as shown at 520, the UE decodes the SSB. For example, the UE may decode the SSB and then determine the first information and the second information associated with the PBCH. The UE may use the first information and the second information associated with the PBCH for communication with one or more BSs.

In certain aspects, the first information (e.g., the common information applicable to the multiple gNBs) may include parameters such as a full or a part of SFN, a half frame number, a full or a part of an SSB index, a network-barring information flag, the SCS, and/or a PDCCH transmission configuration.

In certain aspects, the UE may receive (e.g., from the first BS or other network device) a configuration specifying the parameters (e.g., such as the full or the part of SFN, the half frame number, etc.) included in the common information. The UE may identify the common information in the received PBCH based on the configuration.

In certain aspects, the UE may receive (e.g., from the first BS or other network device) an indication of the parameters (e.g., the full or the part of SFN, the half frame number, etc.) included in the common information. The UE may also receive an indication of a list of BSs, cells, frequencies, frequency ranges, and/or areas sharing the common information. The indication may be received by the UE via: the SIB, a master information block (MIB), a radio resource control (RRC) message, a medium access control-control element (MAC-CE) pre-configuration, and/or over-the-top (OTT) mechanisms.

In certain aspects, the UE may determine a list of BSs (or cells) sharing the common information based on location information associated with each of the multiple BSs (e.g., if the UE may know that two BSs are collocated, the UE may assume the common information is for these two BSs).

In certain aspects, the UE may receive (e.g., from the second BS) an SSB including a PBCH. The PBCH from the second BS may include non-common information related to the second BS and reserved bit values in bits for the common information. In other aspects, the PBCH from the second BS may only include the non-common information related to the second BS.

In one aspect, the PBCH transmitted by the second BS may carry complete PBCH information (including the common and non-common information). However, since the common information is already known by the UE (e.g., received from the first BS), the UE may use this knowledge to simplify its processing of the received PBCH. For instance, the UE may skip PBCH decoding in some cases, or use the known data to improve the efficiency and reliability of detection and decoding. For example, PBCH transmitted by cell 1 may still provide the complete set of system information. However, the UE can leverage its knowledge of the common part to simplify processing. For instance, in certain scenarios, the UE may bypass PBCH decoding altogether or utilize the known information to enhance the efficiency and reliability of detection and decoding.

In another aspect, the common information may be replaced with the reserved bit values (e.g., all zeros) in the PBCH from the second BS, which may further simplify decoding and processing. For example, the common part may be replaced by certain reserved bit values, such as all zeros, which could further simplify decoding and processing. This approach may be relevant in anchored or assisted scenarios, where the UE receives the information from another source. For example, this method could be applied in multi radio access technology (RAT) single standby (MRSS) scenarios or for secondary (non-primary) cells.

In certain aspects, the non-common information and the common information may be separately encoded using a same coding scheme. In other aspects, the non-common information and the common information may be separately encoded using different coding schemes. For example, the common part and the non-common part may be separately coded, carried, or transmitted.

In certain aspects, the non-common information and the common information may be transmitted by a BS separately over different sets of resources.

In certain aspects, the common information may be transmitted less frequently than the non-common information by a BS. For example, the common information may be transmitted on-demand. In another example, the common information may be omitted from transmission entirely. For example, the common part may be transmitted less frequently, on-demand, or not at all by certain cells.

In certain aspects, the common information may be received by the UE from the multiple BSs on a same frequency using a same modulation scheme and resources. For example, the common information may be transmitted in such a way that all BSs operating on the same frequency may send it with identical modulation and scrambling, using the same set of resources. For example, the common part may be transmitted as a single frequency network (SFN) signal, where all cells operating on the same frequency transmit the common part using the same modulation and scrambling over the same set of resources.

In certain aspects, the non-common information and/or the common information may be received by the UE via a low power (LP) signal. For example, either the common or non-common part may be transmitted using the LP signal, such as a sequence that is simple to process and supported by a low-power wake-up receiver (LP-WUR). Furthermore, either part can be carried through various means, including DMRS, PBCH scrambling ID, a PBCH payload, a new physical channel, new reference signaling, or implicitly via the selection of specific time and frequency resources used to transmit the associated signals.

In certain aspects, the UE may receive (e.g., from the first BS or other network device) an indication of one or more BSs from the multiple BSs that may be configured to transmit or not transmit the common information, via a primary synchronization signal (PSS), a secondary synchronization signal (SSS), an SIB, an RRC message, and/or any layer 1 signaling. The UE may also receive an indication of: the one or more BSs that may be configured to transmit the common information, in response to a request from the UE. The indication may further provide one or more request configurations that may be used for sending the request to the one or more BSs. The UE may also receive an indication of the one or more BSs that may be configured to use reserved bit values in bits for the common information (e.g., instead of including the first information itself in the PBCH). The UE may also receive an indication of the one or more BSs that may be used to determine the common information. For instance, the UE may receive one or more SSBs from at least one of the indicated BSs, and may determine the common information in the PBCH in at least one of the one or more received SSBs.

For example, the techniques proposed herein may support an indication via PSS, SSS, PBCH, other layer 1 signaling, SIB, or RRC to notify the UE whether a cell does not transmit the common information, whether the cell transmits the common information less frequently or on-demand (along with its associated configurations, such as the configurations needed for sending on-demand), whether the cell uses reserved bit values instead of the common information, and where (i.e., which cell or frequency) the UE should go to read the common information.

In certain aspects, the UE may determine the SFN, a beam index, and/or a half frame number associated with a first RAT, based on decoding of the PBCH associated with a second RAT. For example, a 6^{th} generation (6G) UE may obtain information about 6G SFN, beam index, and/or half frame number by decoding a 5G PBCH. In some cases, the UE may infer the 6G SFN, beam index, and/or half frame number either through band definition and/or by decoding the 5G PBCH. As a result, 6G systems may omit SFN, beam index, and/or half frame number transmission, or the UE may leverage SFN, beam index, and/or half frame number information from the 5G PBCH to assist in 6G decoding. For example, a 6G UE may acquire information about the 6G SFN by decoding the 5G PBCH. In the case of MRSS, the UE can infer the SFN for 6G either through the band definition or by decoding the 5G PBCH. As a result, 6G systems may be able to skip SFN transmission altogether, relying instead on the SFN information obtained from the 5G PBCH to support 6G decoding. Additionally, the beam index used in 5G may also be reused in the 6G context.

In certain aspects, the UE may receive (e.g., from the first BS or other network device) an indication of quasi co-location (QCL) relationship between SSBs associated with different RATs. For instance, the techniques proposed herein may provide support for indicating the QCL relationship between 5G and 6G SSBs. For example, an indication of the QCL relationship between 5G and 6G SSBs may be supported. In the case of MRSS, an indication is supported to differentiate between 5G and 6G, which can be conveyed through PSS, SSS, PBCH, or a separate layer 1 signal. Alternatively, differentiation can be achieved through other means such as RRC/SIB/OTT signaling or by splitting frequency rasters, among others.

In some cases, timing or SFN information (or any other common elements) obtained from one RAT can be utilized by another RAT.

In certain aspects, the common information in the PBCH may include different sets of common parameters associated with different sets of BSs, frequencies, frequency ranges, and/or areas. For example, a first set of common parameters in the common information may be associated with a first set of BSs, frequencies, frequency ranges, and/or areas and a second set of common parameters in the common information may be associated with a second set of BSs, frequencies, frequency ranges, and/or areas. For example, the techniques proposed herein may support more than one common part of the PBCH, where each part may include a different set of parameters and can be associated with different sets of cells, frequencies, areas, and other relevant elements.

In certain aspects, the parameters for the non-common information and the common information in the PBCH may be different for different sets of beams. The beams may be indicated via reference signal (RS) indices, such as SSB indices. For example, a first set of one or multiple beams from a first BS may share a common set of parameters and values for the non-common information and the common information with a second set of one or multiple beams from a second BS. For example, the techniques proposed herein may support a beam-specific split of common and non-common information of the PBCH. In this context, a first set comprising one or more beams from a first cell may share a set of common values with a second set comprising one or more beams from a second cell.

In certain aspects, the UE may transmit the common information received from the first BS to the multiple BSs. For example, the techniques proposed herein may support sharing common information (e.g., usable across multiple BSs) and/or associated cells among multiple UEs (e.g., as part of UE collaboration framework).

In certain aspects, the techniques proposed herein may support the reconfiguration of the split between the common and non-common information of the PBCH, as well as the associated cells, frequencies, and other related elements.

In certain aspects, the techniques proposed herein may support a validity timer and/or area for provided information (e.g., of the PBCH).

In certain aspects, the UE may receive (e.g., from the first BS or other network device) an indication of one or more frame offset values and/or one or more symbol offset values between different sets of BSs. For example, if certain BSs are not aligned, the techniques proposed herein may provide support for indicating to the UE a frame offset and/or offsets at a half-frame, slot, or symbol level between two sets of one or more BSs. For example, if some cells are not SFN-aligned, the techniques proposed herein may support the indication of SFN and/or half-frame, slot, and/or symbol offsets between two sets of one or multiple cells. These techniques can also support the indication of multiple offsets for multiple sets of cells or frequencies. Signaling methods similar to those used in other cases may be applied. This approach can be specifically adopted for MRSS between 6G and 5G cells.

In certain aspects, such as the examples related to MRSS, certain information such as the SFN can be transmitted via the 5G SSB. In such cases, this information can be omitted from the 6G SSB or PBCH. However, as 5G deployments gradually phase out over time, some 6G cells may need to carry the full set of information (e.g., SFN). Therefore, a mechanism may be desirable to indicate whether a 6G cell transmits the SFN or not.

The techniques proposed herein may support signaling to the UE to convey which information may or may not be carried by the 6G PBCH. This signaling may be delivered through the PSS, SSS, PBCH, or other layer 1 signaling mechanisms, as well as via SIB or RRC signaling. In addition to these signaling methods, the required information may also be delivered through alternative means such as: the DMRS associated with PBCH, PBCH content variations based on synchronization raster configurations (e.g., synchronization rasters dependent (e.g., PBCH contents or possible PBCH contents for different synchronization rasters may be different)), blind decoding of multiple PBCH payload hypotheses, or a combination of the above signaling methods.

### Example Method for Wireless Communications

FIG. 7 shows an example of a method 700 for wireless communications at a wireless node. For example, the wireless node may be a UE such as the UE 104 described above with respect to FIG. 1 and FIG. 3.

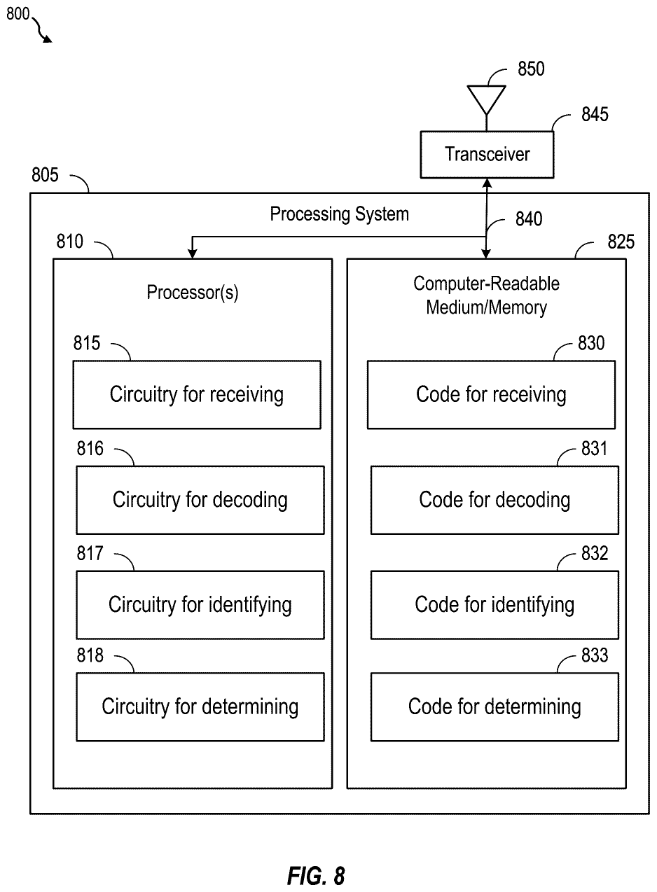

Method 700 begins at 710 with receiving a synchronization signal block (SSB) including at least a physical broadcast channel (PBCH) from a first network entity. In some cases, the operations of this step refer to, or may be performed by, circuitry for receiving and/or code for receiving as described with reference to FIG. 8.

The PBCH includes first information applicable to multiple network entities including at least the first network entity and a second network entity and second information that is specific to one or more of the multiple network entities.

Method 700 then proceeds to 720 with decoding the SSB. In some cases, the operations of this step refer to, or may be performed by, circuitry for decoding and/or code for decoding as described with reference to FIG. 8.

In certain aspects, the first information includes at least one of: a full or a part of system frame number, a half frame number, a full or a part of SSB index, a network entity barring information flag, a subcarrier spacing, or a physical downlink control channel (PDCCH) transmission configuration (for RMSI UE).

In certain aspects, the method 700 further includes receiving a configuration specifying parameters included in the first information, and identifying the first information in the PBCH based on the configuration.

In certain aspects, the method 700 further includes receiving an indication of at least one of: parameters included in the first information or a list of network entities sharing the first information, wherein the indication is received via: a system information block (SIB), a master information block (MIB), a radio resource control (RRC) message, or a medium access control-control element (MAC-CE).

In certain aspects, the method 700 further includes determining a list of network entities sharing the first information based on location information associated with each of the multiple network entities.

In certain aspects, the method 700 further includes receiving an SSB comprising at least a PBCH from the second network entity. The PBCH includes second information related to the second network entity and reserved bit values in bits for the first information.

In certain aspects, the method 700 further includes receiving an SSB comprising at least a PBCH from the second network entity. The PBCH includes second information related to the second network entity.

In certain aspects, at least one of: the second information and the first information are separately encoded using a same coding scheme or different coding schemes; the second information and the first information are transmitted separately over different sets of resources; or the first information is transmitted less frequently than the second information, transmitted on-demand, or omitted from transmission entirely.

In certain aspects, the first information is received from the multiple network entities on a same frequency using a same modulation scheme and resources.

In certain aspects, at least one of: the second information or the first information is received via: a low power (LP) signal, a demodulation reference signal (DMRS), a PBCH scrambling identifier (ID), a payload of the PBCH, a new channel, or a new reference signal.

In certain aspects, the method 700 further includes receiving an indication of one or more network entities from the multiple network entities configured to transmit or not transmit the first information.

In certain aspects, the method 700 further includes receiving an indication of: one or more network entities from the multiple network entities configured to transmit the first information in response to a request from the UE and one or more request configurations for sending the request to the one or more network entities.

In certain aspects, the method 700 further includes receiving an indication of one or more network entities from the multiple network entities configured to use reserved bit values in bits for the first information.

In certain aspects, the method 700 further includes receiving an indication of one or more network entities from the multiple network entities to use to determine the first information; receiving one or more SSBs from the one or more network entities; and determining the first information based on PBCH information in at least one of the one or more SSBs.

In certain aspects, the method 700 further includes determining a system frame number associated with a first radio access technology (RAT) based on decoding the PBCH associated with a second RAT.

In certain aspects, the method 700 further includes receiving an indication of quasi co-location (QCL) relationship between SSBs associated with different RATs.

In certain aspects, at least one of: the first information comprises different sets of common parameters associated with different sets of network entities; or parameters for the second information and the first information in the PBCH are different for different sets of beams.

In certain aspects, the method 700 further includes transmitting the first information to the multiple network entities.

In certain aspects, the method 700 further includes receiving an indication of at least one of: one or more frame offset values or one or more symbol offset values between different sets of network entities.

In one aspect, the method 700, or any aspect related to it, may be performed by an apparatus, such as a wireless node 800 of FIG. 8, which includes various components operable, configured, or adapted to perform the method 700. The wireless node 800 is described below in further detail.

Note that FIG. 7 is just one example of a method, and other methods including fewer, additional, or alternative steps are possible consistent with this disclosure.

### Example Wireless Node

FIG. 8 depicts aspects of an example wireless node 800. In one example, the wireless node 800 may be the UE 104 described above with respect to FIG. 1 and FIG. 3. In another example, the wireless node 800 may be the 5GC 190 of FIG. 1, or the BS 102 of FIG. 1 and FIG. 3.

The wireless node 800 includes a processing system 805 coupled to a transceiver 845 (e.g., a transmitter and/or a receiver). The transceiver 845 is configured to transmit and receive signals for the wireless node 800 via an antenna 850, such as the various signals as described herein. The processing system 805 may be configured to perform processing functions for the wireless node 800, including processing signals received and/or to be transmitted by the wireless node 800.

The processing system 805 includes one or more processors 810. In various aspects, the one or more processors 810 may be representative of one or more of receive processor 358, transmit processor 364, TX MIMO processor 366, and/or controller/processor 380, as described with respect to FIG. 3. In other aspects, one or more processors 810 may be representative of one or more of receive processor 338, transmit processor 320, TX MIMO processor 330, and/or controller/processor 340, as described with respect to FIG. 3.

The one or more processors 810 are coupled to a computer-readable medium/memory 825 via a bus 840. In certain aspects, the computer-readable medium/memory 825 is configured to store instructions (e.g., computer-executable code) that when executed by the one or more processors 810, may cause the one or more processors 810 to perform the method 700 described with respect to FIG. 7 and/or any aspect related to it. Note that reference to a processor performing a function of the wireless node 800 may include the one or more processors 810 performing that function of the wireless node 800.

In the depicted example, the computer-readable medium/memory 825 stores code (e.g., executable instructions), such as code for receiving 830, code for decoding 831, code for identifying 832, and code for determining 833. Processing of the code for receiving 830, the code for decoding 831, the code for identifying 832, and the code for determining 833 may cause the wireless node 800 to perform the method 700 described with respect to FIG. 7 and/or any aspect related to it.

The one or more processors 810 include circuitry configured to implement (e.g., execute) the code stored in the computer-readable medium/memory 825, including circuitry such as circuitry for receiving 815, circuitry for decoding 816, circuitry for identifying 817, and circuitry for determining 818. Processing with the circuitry for receiving 815, the circuitry for decoding 816, the circuitry for identifying 817, and the circuitry for determining 818 may cause the wireless node 800 to perform the method 700 described with respect to FIG. 7 and/or any aspect related to it.

Various components of the wireless node 800 may provide means for performing the method 700 described with respect to FIG. 7 and/or any aspect related to it.

Means for receiving or obtaining may include transceivers 354 and/or antenna(s) 352 of the UE 104 illustrated in FIG. 3; or transceivers 332 and/or antenna(s) 334 of the BS 102 illustrated in FIG. 3. Means for receiving or obtaining may further include code for receiving 830, the circuitry for receiving 815, the transceiver 845 and the antenna 850 of the wireless node 800 in FIG. 8.

Means for decoding may include processors, transceivers 354 and/or antenna(s) 352 of the UE 104 illustrated in FIG. 3; or processors, transceivers 332 and/or antenna(s) 334 of the BS 102 illustrated in FIG. 3. Means for decoding may further include the code for decoding 831, the circuitry for decoding 816, the transceiver 845 and the antenna 850 of the wireless node 800 in FIG. 8.

Means for identifying may include processors, transceivers 354 and/or antenna(s) 352 of the UE 104 illustrated in FIG. 3; or processors, transceivers 332 and/or antenna(s) 334 of the BS 102 illustrated in FIG. 3. Means for identifying may further include the code for identifying 832, the circuitry for identifying 817, the transceiver 845 and the antenna 850 of the wireless node 800 in FIG. 8.

Means for determining may include processors, transceivers 354 and/or antenna(s) 352 of the UE 104 illustrated in FIG. 3; or processors, transceivers 332 and/or antenna(s) 334 of the BS 102 illustrated in FIG. 3. Means for determining may further include the code for determining 833, the circuitry for determining 818, the transceiver 845 and the antenna 850 of the wireless node 800 in FIG. 8.

In some cases, rather than transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive multiple-input and multiple-output (MIMO) processors, modulators, demodulators, and the like, such as depicted in the examples in FIG. 3.

In some cases, rather than receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 8 is an example, and many other examples and configurations of the wireless node 800 are possible.

### Example Clauses

Implementation examples are described in the following numbered clauses:
Clause 1: A method for wireless communications at a user equipment (UE), comprising: receiving a synchronization signal block (SSB) comprising at least a physical broadcast channel (PBCH) from a first network entity, wherein the PBCH comprises, 1) first information applicable to multiple network entities comprising at least the first network entity and a second network entity and 2) second information that is specific to one or more of the multiple network entities; and decoding the SSB.
Clause 2: The method of clause 1, wherein the first information comprises at least one of: a full or a part of system frame number, a half frame number, a full or a part of SSB index, a network entity barring information flag, a subcarrier spacing, or a physical downlink control channel (PDCCH) transmission configuration.
Clause 3: The method of any one of clauses 1-2, further comprising: receiving a configuration specifying parameters included in the first information; and identifying the first information in the PBCH based on the configuration.
Clause 4: The method of any one of clauses 1-3, further comprising receiving an indication of at least one of: parameters included in the first information or a list of network entities sharing the first information, wherein the indication is received via: a system information block (SIB), a master information block (MIB), a radio resource control (RRC) message, or a medium access control-control element (MAC-CE).
Clause 5: The method of any one of clauses 1-4, further comprising determining a list of network entities sharing the first information based on location information associated with each of the multiple network entities.
Clause 6: The method of any one of clauses 1-5, further comprising receiving an SSB comprising at least a PBCH from the second network entity, wherein the PBCH comprises second information related to the second network entity and reserved bit values in bits for the first information.
Clause 7: The method of any one of clauses 1-6, further comprising receiving an SSB comprising at least a PBCH from the second network entity, wherein the PBCH comprises second information related to the second network entity.
Clause 8: The method of any one of clauses 1-7, wherein at least one of: the second information and the first information are separately encoded using a same coding scheme or different coding schemes; the second information and the first information are transmitted separately over different sets of resources; or the first information is transmitted less frequently than the second information, transmitted on-demand, or omitted from transmission entirely.
Clause 9: The method of any one of clauses 1-8, wherein the first information is received from the multiple network entities on a same frequency using a same modulation scheme and resources.
Clause 10: The method of any one of clauses 1-9, wherein at least one of: the second information or the first information is received via: a low power (LP) signal, a demodulation reference signal (DMRS), a PBCH scrambling identifier (ID), a payload of the PBCH, a new channel, or a new reference signal.
Clause 11: The method of any one of clauses 1-10, further comprising receiving an indication of one or more network entities from the multiple network entities configured to transmit or not transmit the first information.
Clause 12: The method of any one of clauses 1-11, further comprising receiving an indication of: one or more network entities from the multiple network entities configured to transmit the first information in response to a request from the UE and one or more request configurations for sending the request to the one or more network entities.
Clause 13: The method of any one of clauses 1-12, further comprising receiving an indication of one or more network entities from the multiple network entities configured to use reserved bit values in bits for the first information.
Clause 14: The method of any one of clauses 1-13, further comprising: receiving an indication of one or more network entities from the multiple network entities to use to determine the first information; receiving one or more SSBs from the one or more network entities; and determining the first information based on PBCH information in at least one of the one or more SSBs.

Clause 15: The method of any one of clauses 1-14, further comprising determining a system frame number associated with a first radio access technology (RAT) based on decoding the PBCH associated with a second RAT.

Clause 16: The method of any one of clauses 1-15, further comprising receiving an indication of quasi co-location (QCL) relationship between SSBs associated with different radio access technologies (RATs).

Clause 17: The method of any one of clauses 1-16, wherein at least one of: the first information comprises different sets of common parameters associated with different sets of network entities; or parameters for the second information and the first information in the PBCH are different for different sets of beams.

Clause 18: The method of any one of clauses 1-17, further comprising transmitting the first information to the multiple network entities.

Clause 19: The method of any one of clauses 1-18, further comprising receiving an indication of at least one of: one or more frame offset values or one or more symbol offset values between different sets of network entities.

Clause 20: An apparatus, including: at least one memory including instructions; and one or more processors configured, individually or in any combination, to execute the instructions and cause the apparatus to perform a method in accordance with any one of Clauses 1-19.

Clause 21: An apparatus, including means for performing a method in accordance with any one of Clauses 1-19.

Clause 22: A non-transitory computer-readable medium including executable instructions that, when executed by one or more processors of an apparatus, cause the apparatus to perform a method in accordance with any one of Clauses 1-19.

Clause 23: A computer program product embodied on a computer-readable storage medium including code for performing a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
one or more memories comprising instructions; and
one or more processors, individually or collectively, configured to execute the instructions to cause the apparatus to:
receive a synchronization signal block (SSB) comprising at least a physical broadcast channel (PBCH) from a first network entity, wherein the PBCH comprises, 1) first information applicable to multiple network entities comprising at least the first network entity and a second network entity and 2) second information that is specific to one or more of the multiple network entities; and
decode the SSB.

2. The apparatus of claim 1, wherein the first information comprises at least one of:
a full or a part of system frame number,
a half frame number,
a full or a part of SSB index,
a network entity barring information flag,
a subcarrier spacing, or
a physical downlink control channel (PDCCH) transmission configuration.

3. The apparatus of claim 1, wherein the one or more processors, individually or collectively, are configured to execute the instructions to cause the apparatus to:
receive a configuration specifying parameters included in the first information; and
identify the first information in the PBCH based on the configuration.

4. The apparatus of claim 1, wherein the one or more processors, individually or collectively, are configured to execute the instructions to cause the apparatus to receive an indication of at least one of: parameters included in the first information or a list of network entities sharing the first information, wherein the indication is received via:
a system information block (SIB),
a master information block (MIB),
a radio resource control (RRC) message, or
a medium access control-control element (MAC-CE).

5. The apparatus of claim 1, wherein the one or more processors, individually or collectively, are configured to execute the instructions to cause the apparatus to determine a list of network entities sharing the first information based on location information associated with each of the multiple network entities.

6. The apparatus of claim 1, wherein the one or more processors, individually or collectively, are configured to execute the instructions to cause the apparatus to receive an SSB comprising at least a PBCH from the second network entity, wherein the PBCH comprises second information related to the second network entity and reserved bit values in bits for the first information.

7. The apparatus of claim 1, wherein the one or more processors, individually or collectively, are configured to execute the instructions to cause the apparatus to receive an SSB comprising at least a PBCH from the second network entity, wherein the PBCH comprises second information related to the second network entity.

8. The apparatus of claim 1, wherein at least one of:
the second information and the first information are separately encoded using a same coding scheme or different coding schemes;
the second information and the first information are transmitted separately over different sets of resources; or
the first information is transmitted less frequently than the second information, transmitted on-demand, or omitted from transmission entirely.

9. The apparatus of claim 1, wherein the first information is received from the multiple network entities on a same frequency using a same modulation scheme and resources.

10. The apparatus of claim 1, wherein at least one of: the second information or the first information is received via:
a low power (LP) signal,
a demodulation reference signal (DMRS),
a PBCH scrambling identifier (ID),
a payload of the PBCH,
a new channel, or a new reference signal.

11. The apparatus of claim 1, wherein the one or more processors, individually or collectively, are configured to execute the instructions to cause the apparatus to receive an indication of one or more network entities from the multiple network entities configured to transmit or not transmit the first information.

12. The apparatus of claim 1, wherein the one or more processors, individually or collectively, are configured to execute the instructions to cause the apparatus to receive an indication of: one or more network entities from the multiple network entities configured to transmit the first information in response to a request from the UE and one or more request configurations for sending the request to the one or more network entities.

13. The apparatus of claim 1, wherein the one or more processors, individually or collectively, are configured to execute the instructions to cause the apparatus to receive an indication of one or more network entities from the multiple network entities configured to use reserved bit values in bits for the first information.

14. The apparatus of claim 1, wherein the one or more processors, individually or collectively, are configured to execute the instructions to cause the apparatus to:
receive an indication of one or more network entities from the multiple network entities to use to determine the first information;
receive one or more SSBs from the one or more network entities; and
determine the first information based on PBCH information in at least one of the one or more SSBs.

15. The apparatus of claim 1, wherein the one or more processors, individually or collectively, are configured to execute the instructions to cause the apparatus to determine a system frame number associated with a first radio access technology (RAT) based on decoding the PBCH associated with a second RAT.

16. The apparatus of claim 1, wherein the one or more processors, individually or collectively, are configured to execute the instructions to cause the apparatus to receive an indication of quasi co-location (QCL) relationship between SSBs associated with different radio access technologies (RATs).

17. The apparatus of claim 1, wherein at least one of:
the first information comprises different sets of common parameters associated with different sets of network entities; or
parameters for the second information and the first information in the PBCH are different for different sets of beams.

18. The apparatus of claim 1, wherein the one or more processors, individually or collectively, are configured to execute the instructions to cause the apparatus to at least one of:
transmit the first information to the multiple network entities, or
receive an indication of at least one of: one or more frame offset values or one or more symbol offset values between different sets of network entities.

19. A method for wireless communications at a user equipment (UE), comprising:
receiving a synchronization signal block (SSB) comprising at least a physical broadcast channel (PBCH) from a first network entity, wherein the PBCH comprises, 1) first information applicable to multiple network entities comprising at least the first network entity and a second network entity and 2) second information that is specific to one or more of the multiple network entities; and
decoding the SSB.

20. A non-transitory computer-readable medium comprising executable instructions that, when executed by one or more processors of a user equipment (UE), cause the UE to perform a method for wireless communications, comprising:
receiving a synchronization signal block (SSB) comprising at least a physical broadcast channel (PBCH) from a first network entity, wherein the PBCH comprises, 1) first information applicable to multiple network entities comprising at least the first network entity and a second network entity and 2) second information that is specific to one or more of the multiple network entities; and
decoding the SSB.
